(19) United States
(12) Patent Application Publication
(10) Pub. No.: US 2004/0116103 A1
(43) Pub. Date: Jun. 17, 2004

(54) Telephone device, call-reception operating method, and call-reception operating program

(75) Inventor: Takeshi Kurihara, Yokohama-shi (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd.

(21) Appl. No.: 10/728,313

(22) Filed: Dec. 4, 2003

(30) Foreign Application Priority Data
Dec. 5, 2002 (JP) P. 2002-353953

(51) Int. Cl. H04M 11/00

(52) U.S. Cl. 455/405

(57) ABSTRACT

The present invention provides a telephone device including a control unit having a call-reception history registering unit which separately sorts a call-reception history into a selected folder among a plural folders provided in a memory of the telephone device. The folders are used for storing call-reception histories according to operations to be applied thereto, for example, a rejection operation, neglecting operation, normal operation, or such. When an incoming call arrives, the control unit measures a calling time of the incoming call and the measured calling time is compared to a pre-selected time by the calling time determining unit. According to the result to the comparison, an operation applied to the incoming call is determined. Then, the control unit sorts a call-reception history corresponding to the incoming call into a selected folder among the plural folders provided in a memory of the telephone device.

### BACKGROUND OF THE INVENTION

1. Field of the Invention

The present invention is related to a telephone device, a call-reception operating method, and a call-reception operating program, in which a caller number is notified when an incoming call arrives.

2. Description of the Related Art

Conventionally, portable telephones are equipped with a call-reception history storage function. In this call-reception history memory function, when incoming calls are received, histories of these incoming call receptions are surely made up, so that the call reception histories are recorded irrespective of calling times. It should be understood that other types portable telephones are also provided. That is, these portable telephones are equipped with a calling-time memory function by which calling times are measured, and the measured calling times are recorded as call-reception history data.

Currently, such nuisance incoming calls conduct social problems. In these nuisance incoming calls, prank calls which are so-called “one-call reception” are issued to very large numbers of portable telephones which are not specified by prank callers while utilizing computer programs. As a result, incoming calls in very short times are received, and thus, call-reception histories are necessarily recorded. In such a nuisance call, a call-reception rejecting (blocking) registration is manually is carried out with respect to a telephone number which has been once recorded in a call-reception history, so that incoming calls subsequent to a second incoming call issued from the same telephone number can be rejected, or refused (refer to, for example, patent publications 1, 2, 3).

[patent publication 1]

Japanese Laid-open Patent Application No. H10-42036

[patent publication 2]

Japanese Laid-open Patent Application No. H11-252246

[patent publication 3]

Japanese Laid-open Patent Application No. 2000-59502.

However, the above-described portable telephones own such a problem that since the call-reception rejection registering operations must be manually carried out every time the nuisance call is received, cumbersome registering operations must be performed.

### SUMMARY OF THE INVENTION

The present invention has been made to solve the above-described problem of the conventional portable telephone, and therefore, has an object to provide a telephone device, a call-reception operating method, and a call-reception operating program, capable of eliminating cumbersome operation with respect to nuisance calls, while a user operation is not required.

To achieve the above-described object, a telephone device, according to the present invention, is featured by such a telephone device for storing a call-reception history when an incoming call arrives, comprising: call-reception history storage section including a plurality of call-reception history folders used to register thereinto call-reception history information containing a caller number received when the incoming call arrives; calling time measuring unit for measuring a calling time when the incoming call arrives; call-reception history registering unit for comparing the calling time measured by the calling time measuring unit with a set time, and for separately sorting the call-reception history information so as to be registered into the different call-reception history folders included in the call-reception history storage section based upon long/short relationships between the calling time and the set time; and call-reception managing unit operated in such a manner that if the caller number received when the incoming call was received has been registered in any of the plural call-reception history folders of the call-reception history storage section, then the call-reception managing unit executes different operations with respect to the incoming call reception, depending upon such a fact that the caller number has been registered in which call-reception history folder. As a result, the telephone device can eliminate the cumbersome operation with respect to the nuisance calls while the user operation is no longer required.

Also, in the telephone device according to the present invention, the call-reception history storage section includes a first call-reception history folder; the call-reception history registering unit registers such a call-reception history information that a calling time thereof measured by the calling time measuring unit is shorter than, or equal to the set time; and the call-reception managing unit rejects to receive an incoming call of a caller number which has been registered in the first call-reception history folder. Accordingly, the telephone device can reject to receive the incoming calls as to the nuisance calls.

Also, in the telephone device according to the present invention, the telephone device is further comprised of: call-reception number counting unit for counting a total number of call receptions every caller number; and the call-reception history registering unit separately sorts the call-reception history information so as to be registered into the different call-reception history folders of the call-reception history storage section in response to both a calling time measured by the calling time measuring unit and a total number of call receptions from the caller number when the incoming call arrives. As previously explained, since the call-reception history information is separately sorted based upon the combination between the calling time and the call-reception number, the telephone device can manage various operations. Furthermore, since the call-reception history information is separately sorted based upon the calling time duration, the telephone device can avoid such a problem even if not referring to the calling time during the normal telephone operation, namely, a incoming call is mistakenly issued from the telephone number of the nuisance call from the call-reception history.

Also, in the telephone device according to the present invention, the call-reception history storage section includes a first call-reception history folder and a second call-reception history folder; the call-reception history registering unit registers into the first call-reception history folder, such a call-reception history information that a calling time thereof measured by the calling time measuring unit is shorter than, or equal to a first set time, and also, a total number of call receptions from the caller number when the incoming call arrives is larger than, or equal to a pre-selected number; and further the call-reception history registering unit registers into the second call-reception history folder, such a call-reception history information that a calling time thereof is longer than the first set time, and is shorter than, or equal to the second set time, and also, the total number of call receptions is larger than, or equal to the pre-selected time; and the call-reception managing unit rejects to receive a incoming call issued from the caller number which has been registered in the first call-reception history folder, and neglects to receive a incoming call issued from the caller number which has been registered in the second call-reception history folder. As a consequence, the telephone device can perform the call-reception neglecting operation other than the call-reception rejecting operation with respect to the nuisance calls.

Also, in the telephone device according to the present invention, the second set time may be preferably made longer than said first set time.

Also, a call-reception operating method, according to the present invention, is featured by such a call-reception operating method for a telephone device equipped with call-reception history storage section including a plurality of call-reception history folders used to register thereinto call-reception history information containing a caller number received when the incoming call arrives, comprising: a calling time measuring step for measuring a calling time when the incoming call arrives; a call-reception history registering step for comparing the calling time measured by the calling time measuring step with a set time, and for separately sorting the call-reception history information so as to be registered into the different call-reception history folders included in the call-reception history storage section based upon long/short relationships between the calling time and the set time; and a call-reception managing step in which if the caller number received when the incoming call was received has been registered in any of the plural call-reception history folders of the call-reception history storage section, then different operations are executed with respect to the incoming call reception, depending upon such a fact that the caller number has been registered in which call-reception history folder.

Also, in the call-reception operating method according to the present invention, the call-reception history storage section includes a first call-reception history folder; the call-reception history registering step registers such a call-reception history information that a calling time thereof measured by the calling time measuring step is shorter than, or equal to the set time; and the call-reception managing step rejects to receive a incoming call of a caller number which has been registered in the first call-reception history folder.

Also, in the call-reception operating method according to the present invention, the call-reception operating method is further comprised of: a call-reception number counting step for counting a total number of call receptions every caller number; and the call-reception history registering step separately sorts the call-reception history information so as to be registered into the different call-reception history folders of the call-reception history storage section in response to both a calling time measured by the calling time measuring step and a total number of call receptions from the caller number when the incoming call arrives.

Also, in the call-reception operating method according to the present invention, the call-reception history storage section includes a first call-reception history folder and a second call-reception history folder; the call-reception history registering step registers into the first call-reception history folder, such a call-reception history information that a calling time thereof measured by the calling time measuring step is shorter than, or equal to a first set time, and also, a total number of call receptions from the caller number when the incoming call arrives is larger than, or equal to a pre-selected number; and further the call-reception history registering step registers into the second call-reception history folder, such a call-reception history information that a calling time thereof is longer than the first set time, and is shorter than, or equal to the second set time, and also, the total number of call receptions is larger than, or equal to the pre-selected time; and the call-reception managing step rejects to receive an incoming call issued from the caller number which has been registered in the first call-reception history folder, and neglects to receive an incoming call issued from the caller number which has been registered in the second call-reception history folder.

Also, in the call-reception operating method according to the present invention, the second set time may be preferably made longer than the first set time.

Furthermore, a call-reception operating program, according to the present invention, is featured by that this call-reception operating program causes a computer to execute the call-reception operating method as recited in Claim 6, 7, 8, 9, or 10.

### BRIEF DESCRIPTION OF THE DRAWINGS

FIG. 1 is a block diagram for indicating an arrangement of a portable telephone according to a first embodiment of the present invention;

FIG. 2 is an explanatory diagram for explaining a call-reception history stored in a memory;

FIG. 3 is a flow chart for describing a sequential process operation of a call-reception operation executed by the portable telephone of the first embodiment;

FIG. 4 is a block diagram for indicating an arrangement of a portable telephone according to a second embodiment of the present invention;

FIG. 5 is a flow chart for describing a sequential process operation of a call-reception operation executed by the portable telephone of the second embodiment;

FIG. 6 is a flow chart for describing another sequential process operation of the call-reception operation executed by the portable telephone of the second embodiment.

In the drawings, a reference numeral 1 refers to a wireless unit; 2 to a memory; 3 to an operating unit; 4 to a display unit; 5 to a notifying unit (speaker); 6 to a control unit; 21, 22, 24 to a call-reception history folder; 23 to a number registration memory; 60 to a call-reception managing unit; 61 to a caller number registering unit; 62 to a call-reception history registering unit; 620 to a calling time determining unit; 621 to a sort instructing unit.

### DETAILED DESCRIPTION OF THE PREFERRED EMBODIMENTS

Various embodiments as to a telephone device, a call-reception operating method, and a call-reception operating program, according to the present invention, will now be explained in detail in this order of [first embodiment mode] and [second embodiment mode] with reference to drawings. It should be understood that the telephone device according to the present invention applied to a portable telephone equipped with a call-reception history memory function (will be simply referred to as a “portable telephone” hereinafter) will be described. Although both the telephone device and the call-reception operating method, according to the present invention, will be explained in detail, since the call-reception operating program according to the present invention corresponds to such a program capable of executing the above-described call-reception operating method of the present invention, explanations of this call-reception operating method are contained in the below-mentioned explanations as to the call-reception operating method.

First Embodiment Mode

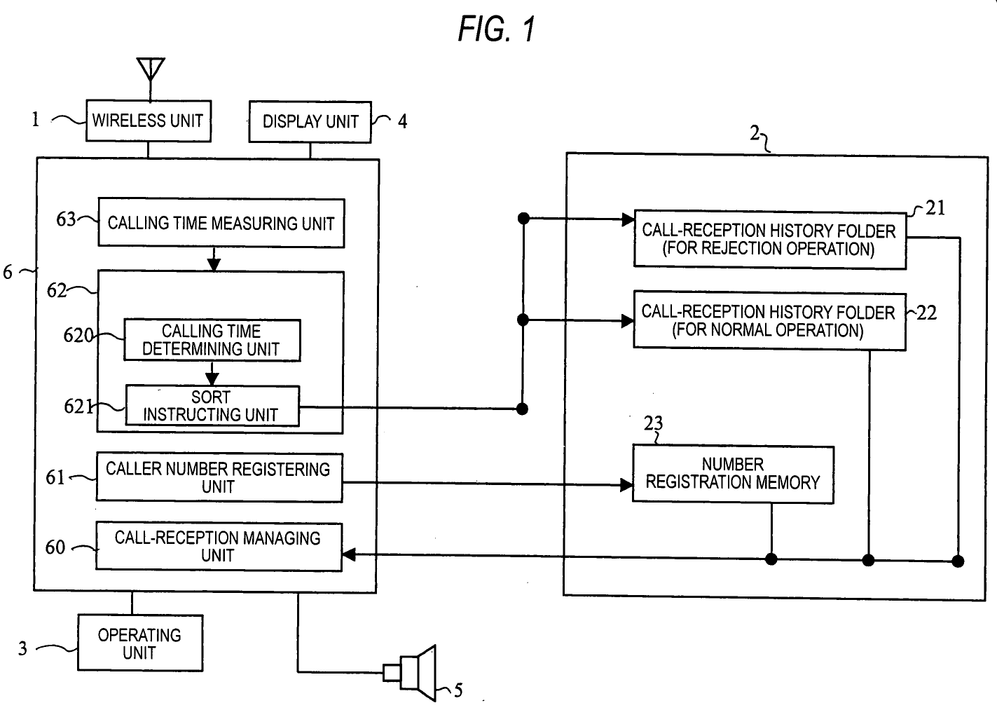

FIG. 1 is a block diagram for indicating an arrangement of a portable telephone according to a first embodiment mode of the present invention. As shown in FIG. 1, the portable telephone of the first embodiment is arranged by employing a wireless unit 1, a memory 2, an operating unit 3, a display unit 4, a speaker 5, and a control unit 6. The wireless unit 1 transmits and/or receives a wireless signal. The memory 2 corresponds to a call-reception history memory means defined in a scope of claim for a patent. The operation unit 3 is operated so as to issue a incoming call, and also to execute various sorts of operations. The display unit 4 displays thereon various sorts of information. The speaker 5 outputs telephone ringing tones and voice. The control unit 6 includes a call-reception history registering unit 62 and a call-reception managing unit 60.

The memory 2 is to store thereinto call-reception histories, registered telephone numbers, operation setting conditions, and the like. This memory 2 owns a call-reception history folder 21 (file folder for call-reception rejection operation), another call-reception history folder 22 (file folder for normal operation), and a number registration memory 23. This call-reception history folder 21 corresponds to a first call-reception history folder defined in the scope of claim for patent. The call-reception history folder 21 (file folder for rejection operation) corresponds to such a folder for conserving thereinto a call-reception history as to incoming calls whose calling times are defined within set times. Also, the call-reception history folder 22 (file folder for normal operation) corresponds to such a folder for conserving thereinto a call-reception history as to incoming calls whose calling times exceed setting times. Also, the number registration memory 23 stores thereinto registered caller numbers, designations of call-reception rejection operations, and the like.

On the other hand, the control unit 6 controls the respective structural elements, and includes a call-reception managing unit 60, a caller number registering unit 61, a call-reception history registering unit 62, and a calling time measuring unit 63. The call-reception history registering unit 62 includes a calling time determining unit 620 and a sort instructing unit 621. This calling time measuring unit 63 measures calling time when an incoming call arrives. Also, the caller number registering unit 61 registers caller numbers of the respective call receptions into the number registration memory 23. The calling time determining unit 620 of the call-reception history registering unit 62 determines as to whether or not a calling time of a call-reception history exceeds a set time in order that a call-reception history is separately sorted into the call-reception history folder 21, or 22 so as to be conserved. Moreover, according to a result of the calling time determining unit 620, the sort instructing unit 621 sorts the call-reception histories into the call-reception history folders. It should be noted that the caller number registering unit 61 may be alternatively registered in the number registration memory 23 in accordance with operation by a user. Alternatively, a caller number conserved in the call-reception history folder 21 may be automatically registered as a telephone number whose incoming call reception is rejected into the number registration memory 23. It may be also possible to register a set of a caller number and an instruction regarding a corresponding operation applied to the caller number in the number registration memory 23.

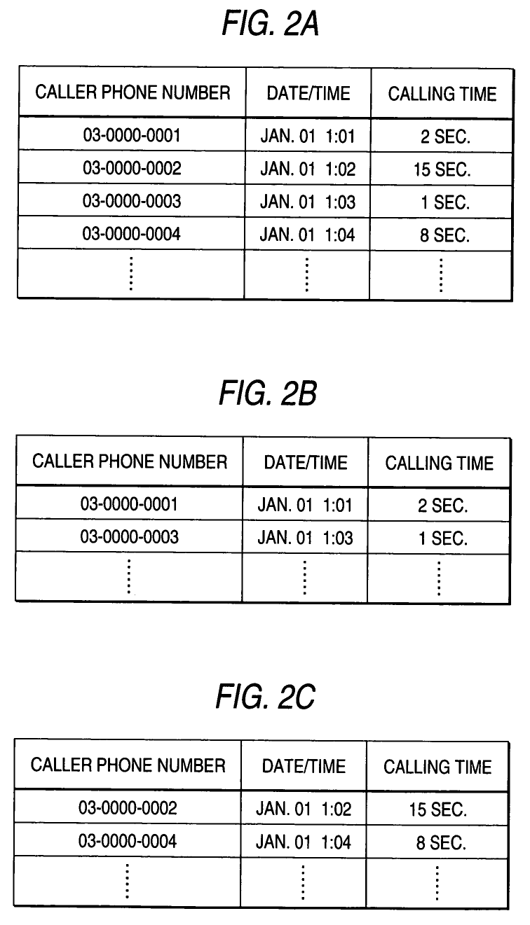

FIG. 2 is an explanatory diagram for explaining a call-reception history stored in the memory 2. FIG. 2A indicates the call-reception history before being separately sorted in accordance with a result made by the calling time determining unit 620. It should be understood that caller numbers, date/time, and calling times are registered in this call-reception history. Also, FIG. 2B shows a call-reception history which has been registered in the call-reception history folder 21 as a result of a judgment made by the calling time determining unit 620. On the other hand, FIG. 2C represents a call-reception history which has been registered in the call-reception history folder 22 as a result of a judgment made by the calling time determining unit 620. The call-reception history shown in FIG. 2B corresponds to such a call-reception history that the calling times are shorter than the set times, whereas the call-reception history indicated in FIG. 2C corresponds to such a call-reception history that the calling times exceed the set times.

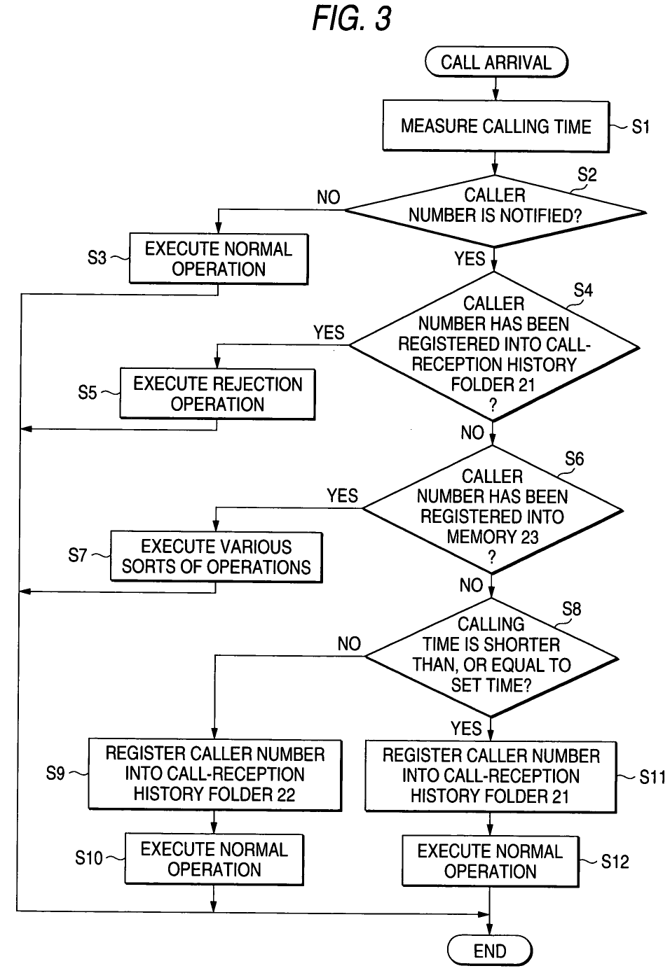

Next, operations (call-reception operating method) of the portable telephone according to this first embodiment will now be described with reference to FIG. 3. FIG. 3 is a flow chart for describing a sequential process operation of the call-reception operation executed by the portable telephone of the first embodiment. It should be understood that this process operation is executed by the control unit 6.

First, when the portable telephone of this first embodiment receives an incoming call, the control unit 6 detects a call-reception signal, and then measures a calling time of this call-reception signal (step S1). Next, the control unit 6 determines as to whether or not a caller number is notified when the incoming call arrives (step S2). When the caller number is notified, the process operation is advanced to a step S4. To the contrary, when the caller number is not notified, the process operation is advanced to a step S3 in which the normal operation is carried out, and then, this process operation is ended.

In the step S4, the control unit 6 determines as to whether or not the caller number is made coincident with a caller number which has been registered into the call-reception history folder 21. When this caller number has been registered in the call-reception history folder 21 in this step S4, the process operation is advanced to a step S5. After a call-reception rejecting operation has been carried out in this step S4, this process operation is accomplished. On the other hand, when this caller number has not been registered, the process operation is advanced to a step 6 in which the control unit 6 confirms as to whether or not the caller number has already been registered in the number registration memory 23. When the caller number has already been registered in this memory 23 in this step S6, the process operation is advanced to a step S7. In this step S7, the control unit 6 executes various sorts of operations corresponding to this caller number, and thereafter, this process operation is ended. On the other hand, when this caller number is not registered in this memory 23, the process operation is advanced to a step S8 in which the control unit 6 determines as to whether or not the calling time is shorter than, or equal to the set time.

In the case that the calling time exceeds the set time in this step S8, the control unit 6 selectively sorts the recording destination of the call-reception history, and thus, registers the call-reception history into the call-reception history folder 22 (step S9), and executes the normal operation (step S10), and thereafter, this process operation is accomplished. On the other hand, in the case that the calling time is shorter than, or equal to the set time, the control unit 6 selectively sorts the recording destination of the call-reception history, and thus, registers the call-reception history into the call-reception history folder 21 (step S11), and executes the normal operation (step S12), and thereafter, this process operation is accomplished It should also be noted that after the call-reception history of the caller number has been selectively sorted so as to register this call-reception history into the call-reception history folder 21 in the step S11, the caller number registered in the call-reception history folder 21 may be automatically registered into the number registration memory 23, and at the same time, the registering operation of this call-reception rejection operation may be carried out.

As previously explained, the portable telephone according to the first embodiment can eliminate the cumbersome operations conducted by the nuisance calls such as a so-called “one-call reception” while the user need not perform the cumbersome manipulations. For instance, with respect to such a call-reception history of a calling time which is shorter than, or equal to such a set time of 2 seconds, the portable telephone can automatically refuse to receive incoming calls subsequent to the second incoming call issued from the same telephone number. Also, a telephone number of an incoming call which is refused to be received may be automatically registered.

Second Embodiment Mode

In the portable telephone of the first embodiment, the user performs the call-reception rejecting operation with respect to the caller number which has been selectively sorted so as to be registered in the call-reception history folder 21. In the portable telephone of the second embodiment, the user can perform not only the call-reception rejecting operation, but also other call-reception managing operations in order to manage nuisance calls in a flexible manner.

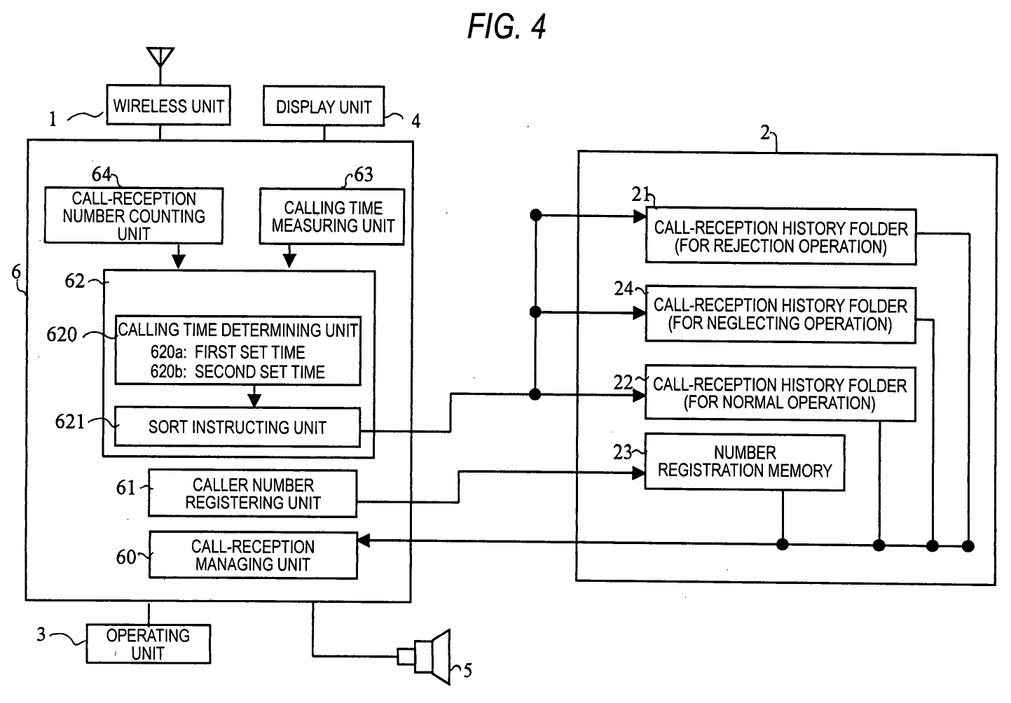

FIG. 4 is a block diagram for indicating an arrangement of the portable telephone according to the second embodiment of the present invention. In this drawing, the same reference numerals shown in FIG. 1 (namely, first embodiment) will be employed as those for denoting the same structural units, and explanations thereof are omitted. As indicated in FIG. 4, the portable telephone of the second embodiment owns a different technical point, as compared with the portable telephone of the first embodiment. That is, in the calling time determining unit 620, two set times (newly, first set time 620a and second set time 620b) are set as a set time which is compared with a calling time when an incoming call arrives. The calling time determining unit 620 further contains a call-reception number counting unit 64 which counts a total number of call-reception operations with respect to each of caller numbers. It should be noted that the second set time 620b is set to be longer than the first set time 620a.

Also, a call-reception history folder 24 (file folder for call-reception neglecting operation) is additionally provided in the memory 2. In this call reception history folder 24, when a subsequent incoming call is issued, a call-reception history as to a caller number whose reception is neglected is registered. It should also be understood that the call-reception number counting unit 64 corresponds to a call-reception number counting unit, and the call-reception history folder 24 (file folder for call-reception neglecting operation) corresponds to a second call-reception history folder, which are defined in the scope of claim for patent.

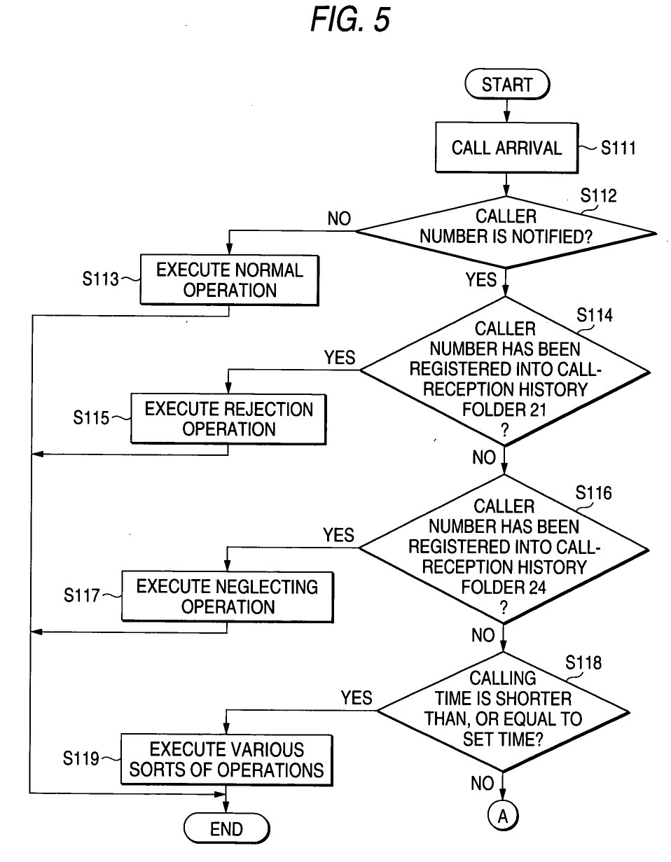

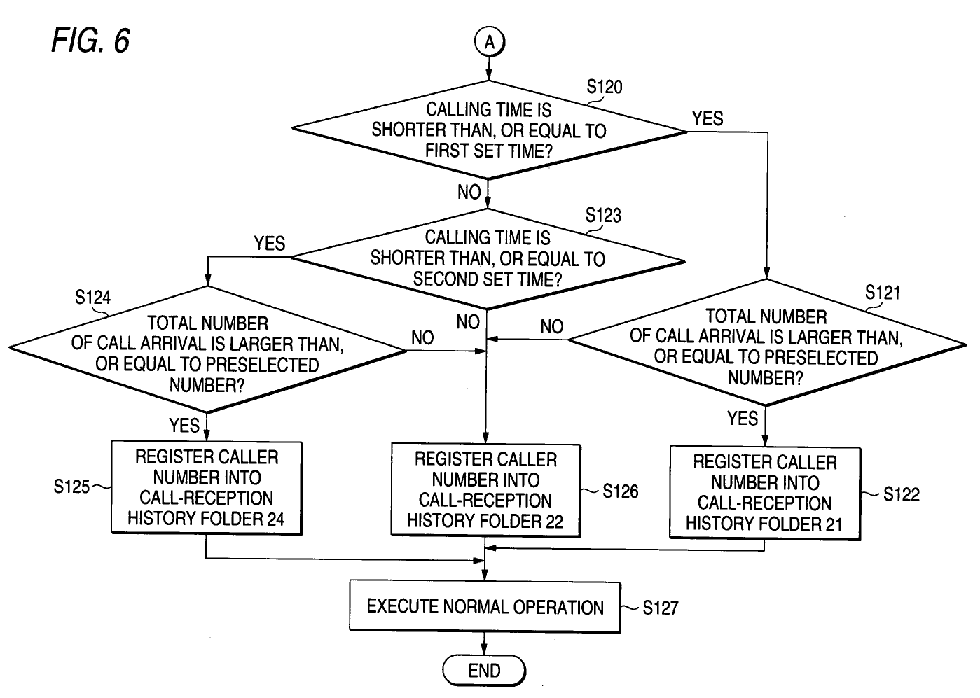

Next, operations (call-reception operating method) of the portable telephone according to this second embodiment will now be described with reference to FIG. 5 and FIG. 6. FIG. 5 and FIG. 6 are flow charts for describing a sequential process operation of the call-reception operation executed by the portable telephone of the second embodiment. It should be understood that this process operation is executed by the control unit 6.

First, when the portable telephone of this second embodiment receives an incoming call, the control unit 6 detects a call-reception signal, and then measures a calling time of this call-reception signal (step S111). Next, the control unit 6 determines as to whether or not a caller number is notified when the incoming call arrives (step S112). When the caller number is notified, the process operation is advanced to a step S114. To the contrary, when the caller number is not notified, the process operation is advanced to a step S113 in which the normal operation is carried out, and then, this process operation is ended.

In the step S114, the control unit 6 determines a to whether or not the caller number is made coincident with a caller number which has been registered into the call-reception history folder 21. When this caller number has been registered in the call-reception history folder 21 in this step S114, the process operation is advanced to a step S115. After a call-reception rejecting operation has been carried out in this step S114, this process operation is accomplished. On the other hand, when this caller number has not yet been registered, the process operation is advanced to a step S116. In this step S116, the control unit 6 determines as to whether or not the caller number is made coincident with a telephone number which has been registered in the call-reception history folder 24. When the caller number is made coincident with the telephone number registered in this folder 24 in this step S16, the process operation is advanced to a step S117. In this step S117, after a call-reception neglecting operation is carried out, this process operation is accomplished. This call reception neglecting operation implies such an operation that even when an incoming call arrives, for example, this call-reception fact is not displayed on the display unit 4, and/or a ringing tone is not produced from the notifying unit (speaker) 5.

On the other hand, when the caller number is not made coincident with the telephone number registered in this folder 24 in this step S116, the process operation is advanced to a step S118. In this step S118, the control unit 6 confirms as to whether or not the caller number has already been registered in the number registration memory 23. When the caller number has already been registered in this step S118, the process operation is advanced to a step S119. In this step S119, the control unit 6 executes various sorts of operations corresponding to this caller number, and thereafter, this process operation is ended. On the other hand, when this caller number is not registered, the process operation is advanced to a step S120 in which the control unit 6 determines as to whether or not the calling time is shorter than, or equal to the first set time 620a.

In such a case that the calling time is shorter than, or equal to the first set time 620a in this step S120, the call-reception number counting unit 64 calculates a call-reception number of this caller number, and determines as to whether or not this calculated call-reception number is larger than, or equal to a predetermined number (step S121). It should also be noted that a call-reception number of such a caller number, the calling time of which is shorter than, or equal to the first set time 620a, may be calculated by counting a call-reception history of this caller number which has been registered in the call-reception history folder 22. In this step S121, when the call-reception number is not reached to a pre-selected number, the call-reception history of this caller number is selectively sorted so as to be registered into the call-reception history folder 22 (step S126). On the other hand, in the case that the call-reception number is larger than, or equal to the pre-selected number in the step S121, after the call-reception history of this caller number is selectively sorted so as to be registered into the call-reception history folder 21 (step S122), the control unit 6 executes the normal operation (step S127), and then this process operation is accomplished.

On the other hand, in such a case that the calling time exceeds the first set time 620a in the step S120, the calling time determining unit 620 determines as to whether or not the calling time is shorter than, or equal to the second setting time 620b (step S123). In such a case that the calling time is shorter than, or equal to the second set time 620b in this step S123, the call-reception number counting unit 64 calculates a call-reception number of this caller number, and determines as to whether or not this calculated call-reception number is larger than, or equal to a predetermined number (step S124). It should also be noted that a call-reception number of such a caller number, the calling time of which is shorter than, or equal to the second set time 620b, may be calculated by counting a call-reception history of this caller number which has been registered in the call-reception history folder 22.

In this step S124, when the call-reception number is not reached to a pre-selected number, the call-reception history of this caller number is selectively sorted so as to be registered into the call-reception history folder 22 (step S126). On the other hand, in the case that the call-reception number is larger than, or equal to the pre-selected number in the step S124, after the call-reception history of this caller number is selectively sorted so as to be registered into the call-reception history folder 24 (step S125), the control unit 6 executes the normal operation (step S127), and then this process operation is accomplished.

Also, in such a case that the calling time exceeds the second set time 620b in the step S123, after the call-reception history of this caller number is selectively sorted so as to be registered into the call-reception history folder 22 (step S126), the control unit 6 executes the normal operation (step S127), and then this process operation is accomplished. Alternatively, after the call-reception histories of the caller numbers have been selectively sorted so as to be registered in the call-reception history folders 21 and 24 respectively in the steps S122 and S125, the caller numbers present in the call-reception history folders 22 and 24 may be automatically registered into the number registration memory 23, and at the same time, the call-reception rejecting operation thereof and the call-reception neglecting operation may be registered.

As previously explained, the portable telephone according to the second embodiment can execute the call-reception neglecting operation other than the call-reception rejecting operation with respect to the nuisance call. Also, since both the calling time and the call-reception number are combined with each other and are separately sorted, the portable telephone can manage various operations. Furthermore, since the time duration of the calling times are separately sorted, the portable telephone can avoid to issue such an erroneous incoming call defined by the nuisance caller number based upon the call-reception history without referring to the calling time when this portable telephone is operated under normal operation mode.

It should also be understood that in the second embodiment, in addition to the call-reception history folder 22 for normal operation, both the call-reception history folder 21 for call-reception rejecting operation and also the call-reception history folder 24 for call-reception neglecting operation are provided. Alternatively, three, or more call-reception history folders may be employed. Further, the call-reception histories of the caller numbers are separately sorted to the respective call-reception history folders based upon the check results as to whether or not the calling time is longer than, or equal to the set time, and furthermore, whether or not the total call-reception number is larger than, or equal to the predetermined number. Alternatively, the call-reception histories of the caller numbers may be separately sorted to the respective call-reception history folders based only on the determined result of the calling time. Also, in such a case that the caller number which has been once separately sorted to the call-reception history folder 24 can satisfy a predetermined condition, for example, in the case that the subsequent call-reception number exceeds a predetermined call-reception number, the call-reception history of this caller number may be transferred from the call-reception history folder 24 for call-reception neglecting operation to the call-reception history folder 21 for call-reception rejecting operation.

Moreover, the above-explained first and second embodiments have described such a case that the telephone device according to the present invention has been applied to the portable telephone Alternatively, this telephone device according to the present invention may be applied to a public telephone, or a home-use telephone.

As previously described, in accordance with the telephone device, the call-reception operating method, and the call-reception operating program, according to the present invention, the cumbersome operations required for managing the nuisance call can be eliminated without the user manipulation.

What is claimed is:

1. A telephone device capable of storing a call-reception history when an incoming call arrives, said telephone device comprising:
a call-reception history storage section including a plurality of call-reception history folders used to register thereinto call-reception history information having a caller number received when the incoming call arrives;
a calling time measuring unit for measuring a calling time;
a call-reception history registering unit for comparing the calling time measured by said calling time measuring unit with a set time, and for separately sorting the call-reception history information so as to be registered into the different call-reception history folders included in said call-reception history storage section based upon long/short relationships between said calling time and said set time; and
a call-reception managing unit operated in such a manner that if the caller number received when the incoming call was received has been registered in any of said plural call-reception history folders of said call-reception history storage section, then said call-reception managing unit executes different operations with respect to said incoming call reception, depending upon such a fact that said caller number has been registered in which call-reception history folder.

2. The telephone device according to claim 1,
wherein said call-reception history storage section includes a first call-reception history folder,
wherein said call-reception history registering unit registers such a call-reception history information that a calling time thereof measured by said calling time measuring unit is shorter than, or equal to said set time, and
wherein said call-reception managing unit rejects an incoming call of a caller number which has been registered in said first call-reception history folder.

3. The telephone device according to claim 1, further comprising:
a call-reception number counting unit for counting a total number of call receptions every caller number,
wherein said call-reception history registering unit separately sorts the call-reception history information so as to be registered into said different call-reception history folders of said call-reception history storage section in response to both a calling time measured by said calling time measuring unit and a total number of call receptions from the caller number when the incoming call arrives.

4. The telephone device according to claim 3,
wherein said call-reception history storage section includes a first call-reception history folder and a second call-reception history folder,
wherein said call-reception history registering unit implement to:
register into said first call-reception history folder a call-reception history information if a calling time of an incoming call measured by said calling time measuring unit is shorter than, or equal to a first set time, and also, a total number of call receptions from a caller number thereof is larger than, or equal to a pre-selected number; and
register into said second call-reception history folder a call-reception history information if a calling time of an incoming call is longer than said first set time, and is shorter than, or equal to said second set time, and also, said total number of call receptions thereof is larger than, or equal to said pre-selected time, and
wherein said call-reception managing unit implement to:
reject an incoming call issued from the caller number which has been registered in said first call-reception history folder; and
neglects to an incoming call issued from the caller number which has been registered in said second call-reception history folder.

5. The telephone device according to claim 4,
wherein said second set time is made longer than said first set time.

6. A call-reception operating method for a telephone device equipped with call-reception history storage section including a plurality of call-reception history folders used to register thereinto call-reception history information containing a caller number, said method comprising:
a calling time measuring step for measuring a calling time when an incoming call arrives;
a call-reception history registering step for comparing the calling time measured by said calling time measuring step with a set time, and for separately sorting the call-reception history information so as to be registered into the different call-reception history folders included in said call-reception history storage section based upon long/short relationships between said calling time and said set time; and
a call-reception managing step in which, if the caller number of said incoming call has been registered in any of said plural call-reception history folders of said call-reception history storage section, different operations are executed with respect to said incoming call depending upon such a fact that said caller number has been registered in which call-reception history folder.

7. The call-reception operating method according to claim 6,
wherein said call-reception history storage section includes a first call-reception history folder,
wherein said call-reception history registering step registers a call-reception history information if a calling time thereof measured by said calling time measuring step is shorter than, or equal to said set time, and
wherein said call-reception managing step rejects an incoming call form a caller number which has been registered in said first call-reception history folder.

8. The call-reception operating method according to claim 6, further comprising:
a call-reception number counting step for counting a total number of call receptions every caller number;
wherein said call-reception history registering step separately sorts the call-reception history information so as to be registered into said different call-reception history folders of said call-reception history storage section in response to both a calling time measured by said calling time measuring step and a total number of call receptions from the caller number when the incoming call arrives.

9. The call-reception operating method according to claim 8,
wherein said call-reception history storage section includes a first call-reception history folder and a second call-reception history folder,
wherein, in said call-reception history registering step:
a call-reception history information is registered into said first call-reception history folder if a calling time of said call-reception history information measured by said calling time measuring step is shorter than, or equal to a first set time, and also, a total number of call receptions from the caller number is larger than, or equal to a pre-selected number; and
a call-reception history information is registered into said second call-reception history folder if a calling time of said call-reception history information is longer than said first set time, and is shorter than, or equal to said second set time, and also, said total number of call receptions is larger than, or equal to said pre-selected time, and
wherein, in said call-reception managing step:
an incoming call is rejected to be received if said incoming call is issued from a caller number corresponding to a call-reception history information which has been registered in said first call-reception history folder;
an incoming call is neglected to be received if said incoming call is issued from a caller number corresponding to a call-reception history information which has been registered in said second call-reception history folder.

10. The call-reception operating method according to claim 9,
wherein said second set time is made longer than said first set time.

11. A program product for causing a computer to execute a call-reception operating method, said method comprising:
a calling time measuring step for measuring a calling time when an incoming call arrives;
a call-reception history registering step for comparing the calling time measured by said calling time measuring step with a set time, and for separately sorting the call-reception history information so as to be registered into the different call-reception history folders included in said call-reception history storage section based upon long/short relationships between said calling time and said set time; and
a call-reception managing step in which, if the caller number of said incoming call has been registered in any of said plural call-reception history folders of said call-reception history storage section, different operations are executed with respect to said incoming call depending upon such a fact that said caller number has been registered in which call-reception history folder.
